(19) United States
(12) Patent Application Publication
(10) Pub. No.: US 2010/0265280 A1
(43) Pub. Date: Oct. 21, 2010

(54) DRIVING CIRCUIT AND GRAY INSERTION METHOD OF LIQUID CRYSTAL DISPLAY

(75) Inventors: Shih-Chieh Yen, Chiayi County (TW); Kuo-Long Tsao, Kaohsiung County (TW); Hsiang-Tan Lin, Keelung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/485,917

(22) Filed: Jun. 17, 2009

(30) Foreign Application Priority Data
Apr. 16, 2009 (TW) 98112686

(51) Int. Cl. G09G 5/10; G09G 3/36

(52) U.S. Cl. 345/691; 345/89

(57) ABSTRACT

A driving circuit and a gray insertion method of a liquid crystal display (LCD) are described. In the gray insertion method, whether a dynamic frame or a static frame display by the LCD is determined. When the LCD displays the dynamic frame, a gray insertion level of a frame of the display and a duty cycle of a pulse width module (PWM) signal are increased synchronously, wherein the PWM signal drives a back light module of the display. When the LCD displays the static frame, the gray insertion level of a frame of the display and the duty cycle of the PWM signal are decreased synchronously. As a result, a motion blur on LCD is reduced and luminance of a display frame is maintained.

### CROSS-REFERENCE TO RELATED APPLICATION

This application claims the priority benefit of Taiwan application serial no. 98112686, filed on Apr. 16, 2009. The entirety of the above-mentioned patent application is hereby incorporated by reference herein and made a part of specification.

### BACKGROUND

1. Field of Invention

The present invention relates to a gray insertion method of a liquid crystal display, more particularly, to a gray insertion method that may suitably adjust the gray insertion level of a frame and synchronously adjust the brightness of a back light to maintain the luminance of an image display.

2. Description of Related Art

The liquid crystal display (LCD) adopts a hold-type display method, and when the LCD displays a dynamic image, motion blur may occur. In general, a gray insertion technique is conventionally adopted to reduce motion blur. A brief illustration is first provided below on how an LCD panel is driven.

A driving signal for an LCD panel mainly includes two parts, a data signal provided by a source driver and a scan signal provided by a gate driver. The data signal mainly provides a voltage signal corresponding to each pixel gray level. The scan signal is used to control a switch signal input from a voltage of each row of pixels. The scan signal scans row by row. Generally speaking, each pixel includes a thin film transistor comprising a gate, a source, and a drain. The scan signal is used to control the conduction of the thin film transistor. When the thin film transistor is turned on, the data signal may charge a pixel storage capacitor through the thin film transistor.

FIG. 1A is a schematic view of scan signals when a conventional LCD panel displays a normal image. Referring to FIG. 1A, when scan signals Gate 01˜Gate N are at logic high levels, the thin film transistor is turned on and the data signal may charge the pixel storage capacitor through the thin film transistor for displaying a normal image.

FIG. 1B is a schematic view of scan signals when a conventional LCD panel displays a normal image and a gray insertion image. When the gray insertion function is activated, a frame may be divided into two sections, a normal frame 101 and a gray insertion frame 102. In the gray insertion frame 102, the time at which the scan signals Gate 01˜Gate N are at logic high levels is fixed.

It should be noted that although the gray insertion technique may improve motion blur of a dynamic image, it may greatly decrease brightness of an image as well. When the LCD displays a static image such as a photograph or a text image, motion blur does not occur. If the gray insertion technique is used in the LCD during the display of a static image, low image contrast is resulted.

Therefore, when the LCD displays a static image, the gray insertion function is manually turned off in the conventional technology. However, turning on and off the gray insertion function results in significant variance in the brightness level of the display image and hence causes great discomfort to the human eye.

### SUMMARY OF THE INVENTION

The present invention provides a gray insertion method of a liquid crystal display which may adjust various levels of gray insertion according to changes in the display images so as to promote image quality.

From another aspect, the present invention provides a driving circuit capable of determining a currently received frame by the LCD to accordingly adjust charging time and a duty cycle of a pulse width modulate signal of a gray insertion frame such that the problems of motion blur as well as low brightness are improved.

The present invention provides a gray insertion method of determining whether a liquid crystal display displays a dynamic frame or a static frame. Furthermore, when the LCD displays a dynamic frame, the gray insertion level of a frame of the LCD is raised and the duty cycle of the PWM signal is simultaneously increased. When the LCD displays a static frame, the gray insertion level of a frame of the LCD is lowered and the duty cycle of the PWM signal is simultaneously reduced. The PWM signal is used for driving a back light module of the LCD.

In one exemplary embodiment of the present invention, the abovementioned step of determining whether the LCD displays a dynamic frame or a static frame includes retrieving a previously display first frame, and a currently display second frame. In addition, when the currently display second frame differs from the aforesaid previously display first frame, the current frame display by the LCD is determined to be a dynamic frame. When the currently display second frame is the same as the aforesaid previously display first frame, the current frame display by the LCD is determined to be a static frame.

In one embodiment of the present invention, the abovementioned step of determining whether the current frame display by the LCD belongs to a dynamic frame or a static frame includes retrieving the previously display first frame and the currently display second frame. In addition, a difference value is generated based on the current frame and the previous frame. When the difference value is larger than a preset value, the current frame display by the LCD is determined to be a dynamic frame. When the difference value is not larger than the preset value, the current frame display by the LCD is determined to be a static frame.

In another exemplary embodiment, the abovementioned step of generating the difference value based on the second frame and the first frame includes analyzing whether the plurality of regions of the first frame is the same as to the plurality of corresponding regions of the second frame, providing that the first frame and the second frame have the same number of regions. Furthermore, the number of different corresponding regions between the first frame and the second frame is determined, and the difference value is decided.

In one exemplary embodiment of the present invention, the abovementioned step of determining whether the current frame display by the LCD belongs to a dynamic frame or a static frame includes retrieving a plurality of previously display first frames and the currently display second frame, calculating a number of continuous changes of the currently display second and the plurality of previously display first frames. When the number of continuous changes is larger than a preset value, the currently display frame is determined to be a dynamic frame. When the number of continuous changes is not larger than the preset value, the currently display frame is determined to be a static frame.

In one exemplary embodiment of the present invention, the above process steps for raising the level of LCD frame gray insertion includes increasing the display time of the gray insertion frame at the frame cycle and the above process steps of lowering the gray insertion level of a frame includes reducing the display time the gray insertion frame at the frame cycle.

In one exemplary embodiment of the present invention, the above process steps for elevating the level of LCD frame gray insertion includes extending the charging time the gray insertion frame and the above process steps of lowering the gray insertion level of a frame includes reducing the charging time the gray insertion frame.

The present invention provides a driving circuit, applicable in an LCD. The driving circuit includes a frame detector, a gray insertion controller, and a back light compensation unit. The frame detector determines whether a second frame belongs to a dynamic frame or a static frame based on a previously display first frame and a second frame received by the LCD. The gray insertion controller is coupled to the frame detector. The back light compensation unit is coupled to the frame detector. When the second frame belongs to a dynamic frame, the gray insertion level of a frame of the LCD is raised by the gray insertion controller and the duty cycle of the PWM signal is simultaneously increased by the back light compensation unit. When the second frame display by the LCD is a static frame, the gray insertion level of a frame of the LCD is lowered by the gray insertion controller and the duty cycle of the PWM signal is simultaneously reduced by the back light compensation unit. Further, the PWM signal is used for driving a back light module of the LCD.

According to one exemplary embodiment of the invention, the above frame detector includes a storage unit for storing the first frame.

According to one exemplary embodiment of the invention, when the first frame is different from the second frame, the frame detector determines the second frame as a dynamic frame. When the first frame is the same as the second frame, the frame detector determines the second frame as a static fame.

According to one exemplary embodiment of the invention, when the frame detector retrieve a difference value between the first fame and the second frame, and the difference value is larger than the preset value, the frame detector may determine the second frame is a dynamic frame. When the difference value is not larger than the preset value, the frame detector may determine the second frame is a static frame.

According to one exemplary embodiment of the invention, the above frame detector further includes a counter. The counter is used in counting a number of different corresponding regions between the first frame and the second frame after the frame detector determines whether corresponding regions of the first frame and the second frame are the same or different, and the number is used as the difference value.

According to one exemplary embodiment of the invention, the above frame detector includes a counter. When two continuous frames are different from each other, a count value of the counter is accumulated; when two continuous images are the same as each other, the count value of the counter is reset. When the count value is larger than a preset value, the frame detector may determine that the second frame is a dynamic frame; when the count value is not larger than the preset value, the frame detector may determine that the current frame is a static frame.

According to one exemplary embodiment of the invention, when the current frame belongs to a dynamic frame, the gray insertion controller extends the display time of a gray insertion frame in a frame cycle. When the current frame belongs to a static frame, the gray insertion controller shortens the display time of a gray insertion frame in a frame cycle.

According to one exemplary embodiment of the invention, when the current frame belongs to a dynamic frame, the gray insertion controller extends the charging time of a gray insertion image. When the current frame belongs to a static frame, the gray insertion controller shortens the charging time of a gray insertion image.

In accordance to the present invention, whether a current frame display by an LCD belongs to a dynamic frame or a static frame is determined. When the current frame display by the LCD is a dynamic frame, the gray insertion level of a frame of the LCD is raised and the duty cycle of the PWM signal is simultaneously increased, wherein the PWM signal is used to drive the back light module of the LCD. When the current frame display by the LCD is a static frame, the gray insertion level of a frame of the LCD is lowered and the duty cycle of the PWM signal is simultaneously reduced. Ultimately, quality of display images may be promoted.

In order to make the aforementioned and other objects, features and advantages of the present invention comprehensible, a preferred embodiment accompanied with figures is described in detail below.

### BRIEF DESCRIPTION OF THE DRAWINGS

FIG. 1A is a schematic view of scan signals when a conventional LCD panel displays a normal image.

FIG. 1B is a schematic view of scan signals when a conventional LCD panel displays a normal image and a gray insertion image.

FIG. 1C is a schematic diagram illustrating the adjustment of a gray insertion level of a frame in accordance to the image according to one exemplary embodiment of the invention.

FIG. 2 is a block diagram of an LCD according to one exemplary embodiment of the invention.

FIG. 3 is a flowchart of a gray insertion method of an LCD according to one exemplary embodiment of the present invention.

FIGS. 4A and 4B are schematic views of a previously display first frame and a currently display second frame.

FIG. 5 is a flowchart of one exemplary embodiment of step S301.

FIG. 6 is a flowchart of another exemplary embodiment of step S301.

FIG. 7 is a block diagram of an LCD according to one exemplary embodiment of the invention.

### DESCRIPTION OF EMBODIMENTS

A conventional gray insertion method may improve motion blur of a dynamic image but may significantly reduce brightness of a dynamic image and a static image. In addition, turning on and off the conventional gray insertion function results in significant variance in the brightness level of the display image and hence causes great discomfort to the human eye.

In light of the above, a gray insertion method of an LCD is provided in accordance to exemplary embodiments of the present invention. The method of the invention determines whether a current frame is a dynamic frame or a static frame. When the LCD displays a dynamic frame, the gray insertion level of a frame of the LCD and the duty cycle of the pulse width modulate (PWM) signal are synchronously increased so as to improve the motion blur condition. In contrast, when the current frame is a static frame, the gray insertion level of a frame of the LCD and the duty cycle of the pulse width modulate (PWM) are synchronously decreased so as to reduce flickering and to maintain luminance of the display frame.

The above-mentioned pulse width modulate signal is used to drive the back light module of the LCD. Moreover, when the above duty cycle of the pulse width modulate (PWM) signal is adjusted, luminance of a frame is compensated during the generation of a gray insertion frame. Further, a sudden variation of brightness of a display image is prevented and thus discomfort to the human eye is reduced when a gray insertion frame is generated. Illustrations on exemplary embodiments of the present invention are described below with reference to the accompanied figures provided for the purpose of explaining the present invention, wherein same numerals denote same or similar elements or steps.

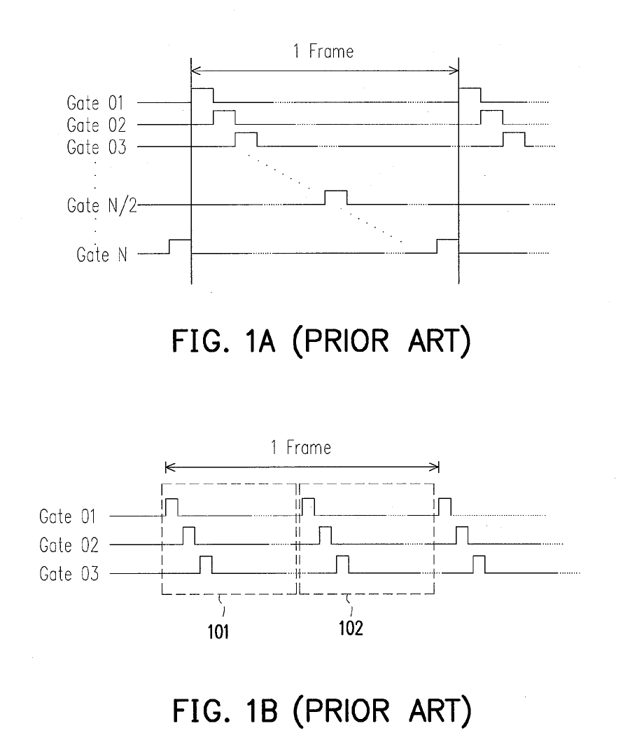

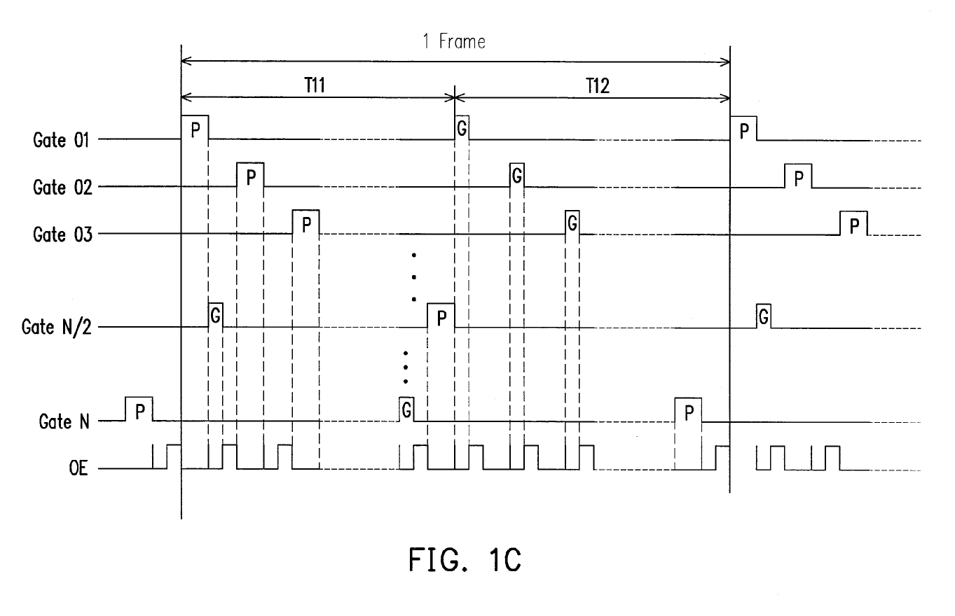

FIG. 1C is a schematic view illustrating the adjustment of the gray insertion level of a frame according to one exemplary embodiment of the present invention. Referring to FIG. 1C, in accordance to the gray insertion method of this exemplary embodiment of the present invention, the LCD current displaying a dynamic frame or a static frame is determined. When the LCD displays a dynamic frame, the display time of a gray insertion frame at a frame cycle is increased, and the duty cycle of the PWM signal is concurrently increased. Alternatively speaking, in the scan signals Gate 01 to Gate N, the time of the pulse G of writing black insertion data is increased. Further, the duty cycle of the PWM signal is proportionally increased according to the time increased, wherein the duty cycle is a proportional value of the pulse width to the period of the PWM signal. Accordingly, the level of dynamic frame gray insertion is enhanced to mitigate the problem of motion blur and to maintain luminance of the display image, wherein the gray insertion frame is written to the display panel during the continuous pulse G of Gate 01 to Gate N.

When the LCD displays a static frame, the display time of the gray insertion frame at the frame cycle may be reduced and the duty cycle of the PWM signal is synchronously reduced. In other words, in the scan signals Gate 01 to Gate N, the time of the pulse G of the writing gray insertion data is decreased (for example, time period T12). Additionally, in accordance to the extent of the time reduced, the duty cycle of the PWM signal is proportionally reduced. Hence, the gray insertion level of a frame of an LCD is lowered to prevent flickering of image and to maintain of 1 luminance of the display image.

Moreover, the gray insertion level of a frame is adjusted via adjusting the charging time of a gray insertion frame. Alternatively speaking, when an LCD displays a dynamic frame, the time of the pulse G of the scan signals Gate 01 to Gate N at a high logic level is increased. When an LCD displays a static frame, the time of the pulse G of the scan signals Gate 01 to Gate N at a high logic level is decreased. It is worthy to note that, in one frame cycle, each pulse (including the pulse G of writing the gray insertion data and the pulse P of the pixel data) respectively corresponds to a different time period in the output enable (OE) signal. Further, the time of each pulse at a high logic level is determined by the period of the corresponding OE signal, wherein the OE signal is at the time of a low logic level.

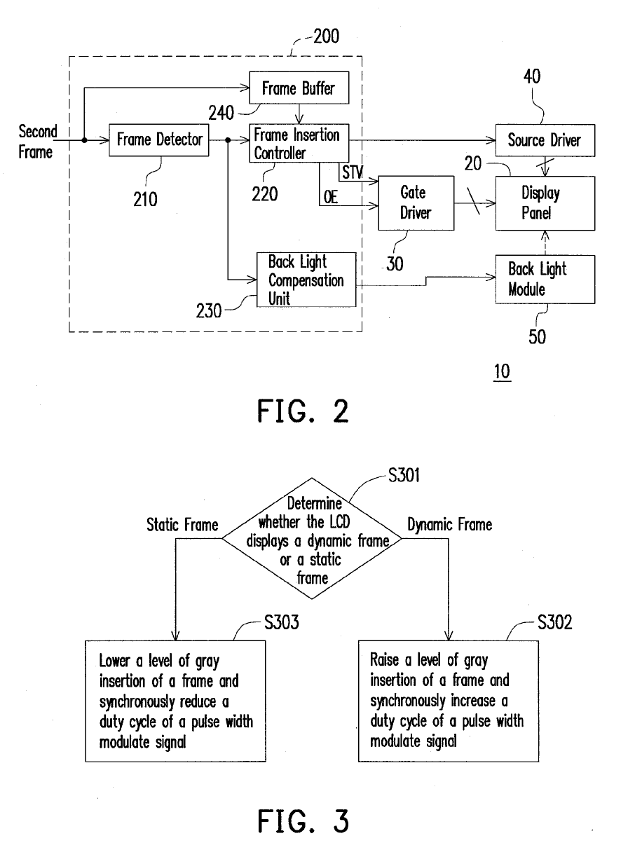

FIG. 2 is a block diagram of an LCD according to one exemplary embodiment of the present invention. In this exemplary embodiment of the present invention, the LCD 10 includes a display panel 20, a gate driver 30, a source driver 40, a back light module 50 and a driving circuit 200. The driving circuit 200 receives the video data (for example, the second frame), and the gate driver 30, the source driver 40 and the back light module 50 are controlled according to the pixel data in the second frame so as to drive the display video data of the display panel 20.

The driving circuit 200 includes a frame detector 210, a gray insertion controller 220, a back light compensation unit 230 and a frame buffer 240. The frame detector 210, which is coupled to the gray insertion controller 220 and the back light compensation unit 230, receives the video data (for example, the second frame). The gray insertion controller 220 is coupled to the gate driver 30 and the source driver 40. The back light compensation unit 230 is coupled to the back light module 50. The frame buffer 240 receives and stores the video data.

The driving circuit 200 receives and concurrently sends the video data (the second frame, for example) to the frame detector 210 and the frame buffer 240. The frame detector 210 then determines whether the second frame to be display by the LCD is a dynamic frame or a static frame according to the first frame (which is the frame prior to the second frame). A determination signal is then generated and sent to the gray controller 220 and the back light compensation unit 230. The gray controller 220 determines whether gray insertion is to be performed according to the determination signal. In essence, the gray controller 220 determines whether to generate a gray insertion frame according to the determination signal in order to adjust the gray insertion level of a frame. The gray controller obtains the required pixel data from the frame buffer 240, sends the required pixel data to the source driver 40 and generates a corresponding vertical start signal STV and an output enable signal. The corresponding vertical start signal STV and the output enable signal are sent to the gate driver 30 for writing the pixel data of the second frame to the corresponding pixel in the display panel 20. The back light compensation unit 230 adjusts the duty cycle of the pulsed width modulate signal according to the determination signal for maintaining luminance of a display of the LCD 10. Reference now is made to the accompanying flow diagrams to describe the exemplary embodiments of the invention. In the following exemplary embodiments, the PWM signal may be generated by the back light compensation unit 230, and the back light compensation unit 230 may include a signal generation unit (not shown) for generating the PWM signal.

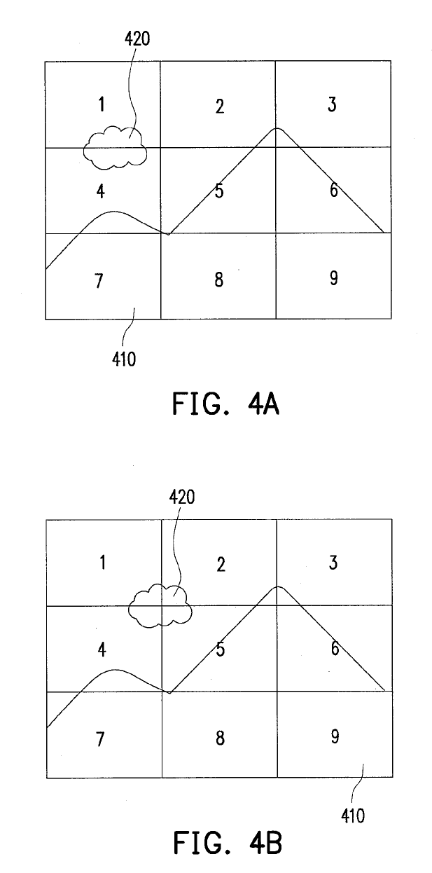

FIG. 3 is a flow diagram of an LCD gray insertion method according to one exemplary embodiment of the invention. FIGS. 4A and 4B are schematic diagram of a first frame and a second frame. Referring concurrently to FIGS. 2, 3, 4A and 4B, assuming that the first frame and the second frame are continuous frames, the first frame and the second frame both include a mountain 410 and a piece of cloud 420. The difference between the first frame and the second frame is the position of the piece of cloud 420. Further, it is assumed that the frame detector 210 and the frame buffer 240 are already stored with the first frame. As the driving circuit 200 receives the second frame, the frame buffer 240 stores the second frame. Moreover, the frame detector 210 determines whether the second frame is a dynamic frame or a static frame; in other words, the second frame to be display by the LCD 10 is determined to be a dynamic frame or a static frame (step S301). If the LCD displays a dynamic frame, step S302 is executed. If the LCD displays a static frame, step S303 is executed. The implementation of step S301 is described below for reference of persons skilled in the art.

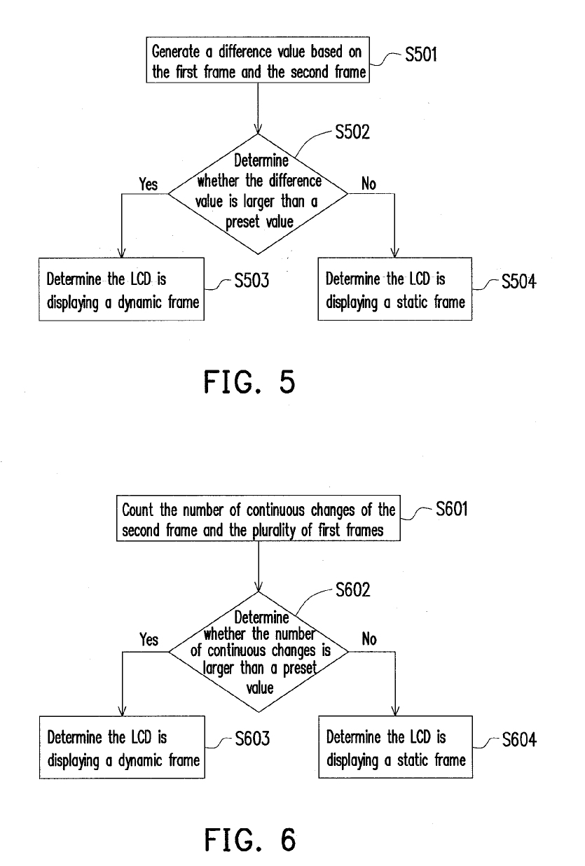

FIG. 5 is a flowchart of one embodiment of step S301. Simultaneously referring to FIG. 2 to FIG. 5, step S301 in the present embodiment may include steps S501˜S504. First, a difference value is generated based on the first frame and the second frame in step S501. For example, a comparison may be made on whether corresponding regions between the first frame and the second frame are the same. Next, the difference value is generated based on the number of the corresponding regions that are different from each other.

More specifically, in the present embodiment, the frame detector 210 compares whether a region 1 of the first frame is the same as a region 1 of the second frame. No counting is performed if the region 1 of the first frame is the same as the region 1 of the second frame; otherwise, the count value is accumulated. In the present embodiment, the region 1 of the first frame is not the same as the region 1 of the second frame, so the count value changes from 0 to 1. Similarly, the frame detector 210 respectively compares whether regions 29 of the first frame are the same as regions 29 of the second frame. In the present exemplary embodiment, the regions 2, 4, and 5 of the first frame are not the same as the regions 2, 4, and 5 of the second frame. Hence, the count value becomes 4 after the frame detector 210 completes the comparison of the regions 29 of the first frame with the regions 29 of the second frame. It should be noted that the count value in the present embodiment may be directly used as the abovementioned difference value, and should not be construed as limited to the embodiments set forth herein. In other embodiments, the count value may be indirectly used as the abovementioned difference value.

Step S502 is then performed after the difference value is obtained. The frame detector 210 may determine whether the difference value is larger than a preset value. If the difference value is larger than the preset value, it is determined that the LCD displaying a dynamic frame (step S503); otherwise, it is determined that the LCD is not displaying a dynamic frame (i.e. a static frame) (step S504). In the present embodiment, the preset value is 4 for the purpose of illustration. Therefore, the difference value is not larger than the preset value. The frame detector 210 determines the current frame is a static frame and accordingly reduces the display time of the gray insertion frame at the frame cycle. It should be noted that the present embodiment uses steps S501˜S504 to implement step S301, which has the advantage that frames with minor changes are not determined as dynamic frames. In other exemplary embodiments, the frame detector 210 may include or couple to a storage unit (not shown) and a counter (not shown) to respectively realize the above storage and counting functions.

Since the current frame in step S301 is determined as a static frame, step S303 is then performed to lower the frame insertion level of the LCD 10 and to synchronously reduce to duty cycle of the PWM signal. The lowering of the gray insertion level of a frame the LCD 10 is achieved through a reduction of the display time of the gray insertion frame at the frame cycle. Concurrently referring to FIG. 1C, and FIG. 2 FIG. 5, in step S303, the gray insertion controller 220 may shorten the display time (for example, period T12) of a gray insertion frame in FIG. 1C. As such, in one frame cycle, as the vertical start signal STV sends the pulse for the first time, the gate driver 30 generates a pulse P for writing the pixel data at the scan signal Gate 01, and this pulse P moves according to time so that the pulse P appears in the scan signal Gate 02 as it disappears in the scan signal Gate 01. Similarly, the pulse P appears in scan signals Gate 03 to Gate N.

As the vertical start signal STV transmits the pulse for the second time, the gate driver 30 generates a pulse G for writing the gray insertion data at the scan signal Gate 01. The pulse G is similar to the pulse P, in which the pulse G moves according to time, and is generated in the scan signals Gate 02 to Gate N. In view of the above, the frame cycle is fixed; accordingly, by increasing the gap between the pulse transmissions of the first time and the second time of the vertical start signal STV in one frame cycle (such as T11), the display time T12 of gray insertion is reduced. In this exemplary embodiment, only one pulse is transmitted in one pixel cycle to stop the generation of gray insertion frame.

For example, when the LCD displays a static frame, the period T12 is shortened from one-third of a frame cycle to zero, and the duty cycle changes from 80% to 60%. Accordingly, the problem of flickering is mitigated when a static frame is display by an LCD. Further, discomfort to the human eye resulted from the significant variance in brightness due to the change in the gray insertion function may be avoided.

It should be further noted that shortening the charging time of a gray insertion frame may be used to lower the gray insertion level of a frame of the LCD 10; in other words, the time of pulse G at high logic level is reduced. In view of the above, at the period in which the pulse G corresponds to the output enable signal, the charging time of a gray insertion frame is reduced by shortening the time of the output enable signal OE at a low logic level. For example, at the period in which the pulse G corresponds to the output enable signal, the charging time of the gray insertion frame changes from one-half to zero when the output enable signal OE is at a high logic level; in other words, a gray insertion frame will not be generated. Further, the duty cycle of the PWM signal changes from 80% to 50%.

Similarly, step S302 is continued if the current frame is determined to be a dynamic frame in step S301. More specifically, in step S302, the gray insertion level of a frame of an LCD is increased and the duty cycle of the PWM signal is synchronously increased. With respect to the adjustment of the display time of the gray insertion frame at the frame cycle, by shortening the period T11, the display time T12 of the gray insertion frame is increased. In essence, when the LCD displays a dynamic frame, the time period T12 increases to one-third of the frame cycle, and the duty cycle changes from 60% to 80%. With respect to the adjustment of the charging time of the gray insertion frame, by extending the time ofthe output enable signal OE at the low logic level, the charging time of a gray insertion frame is extended.

In other words, at the corresponding period in which the pulse G corresponds to the output enable signal, when the output enable signal is at the low logic level for one-half of the time, the charging time of the gray insertion frame changes from zero to one-half of the corresponding period, and the duty cycle of the PWM signal changes from 50% to 80%. Accordingly, the problem of motion blur of an LCD displaying a dynamic frame may be improved. Furthermore, discomfort to the human eye resulted from the significant variance in brightness due to gray insertion of frame may be avoided.

It is worthy to note that after adjusting the gray insertion level of a frame, one skilled in the art may employ various frame scanning methods to display the gray insertion frame. For example, the gray insertion frame is display by the driving circuit 200 of the exemplary embodiment of the invention in connection with a raster scanning method. However, in other embodiments, an interlace scanning method or other scanning method may be adopted to display the gray insertion frame which is not limited by the present invention herein.

Referring to FIG. 5 again, in step S501 of the above exemplary embodiment, a comparison on the nine corresponding regions of the first frame and the second frame is performed to determine whether they are the same so as to generate a difference value. It should be appreciated that the present invention is not limited as such. In other exemplary embodiments, persons skilled in the art may adopt any number of corresponding regions according to requirements in place of the abovementioned nine corresponding regions so as to generate a difference value. Similar effects as those in the abovementioned embodiments may be achieved. The accuracy of the determination that whether the current frame is a dynamic frame will be higher as the number of the corresponding regions increases.

Although the above embodiments have disclosed exemplary types of liquid crystal display and a gray insertion method thereof, it should be appreciated by persons of ordinary knowledge in this art that this invention may be embodied in many different forms and should not be construed as limited to the embodiments set forth herein In other words, any method including a determination of whether a current frame is a dynamic or static frame so as to accordingly determine whether to extend or to shorten charging time of a gray insertion image falls within the spirit of the present invention. Other embodiments are discussed hereinafter to allow persons of ordinary skill in the art to further comprehend and embody the present invention.

In addition, in the above embodiment, steps S501˜S504 disclosed in FIG. 5 is an exemplary embodiment of step S301, which is not limited by the present invention herein. In other embodiments, persons skilled in the art may also adopt other methods to determine whether the current frame is a dynamic frame (step S301). For example, a direct comparison between the first frame and the second frame may be made to determine whether they are the same. If the first frame and the second frame are the same, the display frame is determined to be a static frame; otherwise, the display frame is determined to be a dynamic frame. The advantage of the aforesaid method lies in the simple calculation and that the counting steps may be obviated.

In another example, as illustrated in FIG. 6, FIG. 6 is a flowchart of another embodiment of step S301. Referring to FIG. 2 and FIG. 6 concurrently, step S301 in the present embodiment may include steps S601˜S604. The present embodiment assumes the initial state of the count value of the frame detector 210 to be 0. In step S601, the number of continuous changes of the second frame and a plurality of first frames is counted. More specifically, the frame detector 210 may check whether the first frame and the second frame are the same. If they are the same, the count value is reset; otherwise, the count value is accumulated. In the present embodiment, the count value may be used as the abovementioned number of continuous changes. The first frame and the second frame are assumed to be the same herein so the count value changes from 0 to 1.

Step S602 is performed to determine whether the number of continuous changes is larger than a preset value. If the number of continuous changes is larger than the preset value, the current frame display by the LCD is determined to be a dynamic frame (step S603); otherwise, the current frame display by the LCD is determined to be a static frame (step S604). The preset value is 3, for example, in the present embodiment. The count value is 1, which is not larger than the preset value 3, so the second frame is determined to be a static frame; in other words, the LCD displays a static frame (step S604).

Similarly, when the driving circuit receives the next frame, the abovementioned steps S601˜S604 may be followed to determine whether the next frame display by the LCD is a dynamic frame or a static frame. Persons skilled in the art may deduce from the above descriptions the method of determining whether the current frames in subsequent frame periods are dynamic frames, which is not further illustrated herein.

It should be noted that by using steps S601˜S604 to implement step S301 in according to the present invention, at least the advantage that a plurality of transmitted frames with no changes in a short time not being determined as static frames is provided. Furthermore, although the frame detector 210 of the present embodiment may only store one frame, information of a plurality of previous frames may be indirectly obtained in the present embodiment by integrating the use of the counter. Hence, it is not required to store a plurality of previous frames and storage space of the frame detector 210 may be effectively preserved.

Furthermore, in the present embodiment, the preset value in step S602 is 3 for the purpose of illustration which is not to be construed as limiting the scope of the invention. In other embodiments, persons skilled in the art may decide on the preset value according to requirements. It should be noted that the currently display second frame is more likely to be determined as a static frame with a larger preset value. In contrast, the currently display second frame is more likely to be determined as a dynamic frame with a smaller preset value.

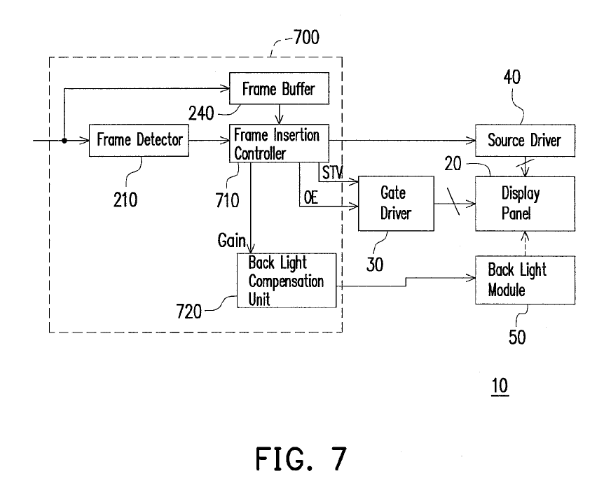

The above-mentioned driving circuit 200 performs a fixed level of gray insertion (for example, a fixed display time T12 or a fixed charging time) when the LCD displays a dynamic frame. However, the frame insertion may be gradually adjusted and the duty cycle of the PWM signal may be synchronously adjusted. FIG. 7 is a block diagram of an LCD according to another exemplary embodiment of the invention. Referring to both FIGS. 2 and 7, the major difference in FIG. 7 from FIG. 2 is the gray insertion controller 710 and the back light compensation unit 720 of the driving circuit 700. The back light compensation unit 720 is coupled to the gray insertion controller 710.When the LCD 10 displays a dynamic frame, the gray insertion controller 710 gradually raises the gray insertion level of a frame of the LCD 10.

Speaking in terms of adjusting the display time of the gray insertion frame at the frame cycle, the gray insertion controller 710 gradually increases the time of the period T12, and outputs a gain signal Gain to control the back light compensation unit 720 and concurrently increases the duty cycle of the PWM signal. With respect to the adjustment of the charging time of the gray insertion frame, during the time period at which the pulse G corresponds to the output enable OE signal, the time of the output enable signal OE at the low logic level is extended in order to extend the charging time of a gray insertion frame. Moreover, the gain signal Gain is outputted to control the back light compensation unit 720 and to concurrently increase the duty cycle of the PWM signal.

In other embodiments, when the display time of the gray insertion frame is less than the lower limit of the display time, the low limit of the display time is used as the display time of the gray insertion frame. Alternatively, when the shortened charging time of the gray insertion frame is less than the lower limit of the charging time, the lower limit of the charging time is used as the charging time of the gray insertion frame. One skilled in the art may set the lower limit display time or the low limit charging time according to requirements. The method may provide at least the advantage of allowing the LCD to maintain a display of a gray insertion frame.

When the LCD 10 displays a static frame, the gray insertion controller 710 gradually lowers the gray insertion level of a frame of the LCD display. With respect to the adjustment of the display time of the gray insertion frame at the frame cycle, the gray insertion controller 710 gradually reduces the time of the time period T12, and outputs the gain signal Gain to control the back light compensation unit 720 and to synchronously reduce the duty cycle of the PWM signal. With respect to the adjustment of the charging time of the gray insertion frame, during the time period in which the pulse G corresponds to the output enable OE signal, the time of the output enable signal OE at the low logic level is reduce in order to reduce the charging time of a gray insertion frame. Moreover, the gain signal Gain is outputted to control the back light compensation unit 720 and to concurrently increase the duty cycle of the PWM signal.

Further, in other exemplary embodiments, when the display time of the gray insertion frame is larger than the upper limit of the display time, the upper limit of the display time is used as the display time of the gray insertion frame. Alternatively, when the extended charging time of the gray insertion frame exceeds the upper limit charging time, the upper limit charging time is used as the charging time of the gray insertion frame. One skilled in the art may set the lower limit display time or the low limit charging time according demands and requirements. The method may provide at least the advantage of allowing the LCD to maintain the display of a normal image.

In accordance to the present invention, whether the second frame (a current frame) display by the LCD is a dynamic frame or a static frame is determined through a frame detector so as to raise or lower the gray insertion level of a frame and to synchronously increase or reduce the duty cycle of the PWM signal. Consequently, to adaptively adjust the gray insertion level of a frame and to synchronously adjust the luminous of back light so as to improve not only motion blur of a dynamic frame but also the loss of brightness of a static frame due to gray insertion. In addition, the embodiments of the present invention further provide at least the following features.
1. Display time or charging time of a gray insertion frame is shortened so the problem of flickering is improved when an LCD displays a static frame.
2. Display time or charging time of a gray insertion frame is extended so the problem of motion blur is improved when an LCD displays a dynamic frame.
3. Duty cycle of a PWM signal is synchronously adjusted so discomfort to the human eye due to overly high variation in brightness of the image is avoided.
4. Steps S501˜S504 are used to implement step S301 so that a frame being determined as a dynamic frame due to minor changes is obviated.
5. A number of corresponding regions is adjusted in step S501 so that accuracy of determining whether the second frame (a currently display frame) is a dynamic frame may be changed.
6. A direct comparison is made to determine whether the second frame (the currently display frame) and the first frame (previously display frame) are the same so as to determine whether the second frame is a dynamic frame, which effectively reduces complexity of calculation.
7. Steps S601˜S604 are used to implement step S301 so that a frame with no changes in a short period being determined as a static frame is obviated.
8. In step S602, a determination of whether a current frame is likely a dynamic frame may be adjusted by modifying the preset value.

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

What is claimed is:

1. A gray insertion method of a liquid crystal display (LCD), comprising:
determining whether a current frame displayed by the LCD is a dynamic frame or a static frame;
raising a gray insertion level of the LCD and concurrently increasing a duty cycle of a pulse width modulate (PWM) signal when the LCD displays the dynamic frame, wherein the PWM signal is used to drive a back light module of the LCD; and
lowering the gray insertion level of the LCD and concurrently reducing the duty cycle of the pulse width modulate (PWM) signal when the LCD displays the static frame.

2. The gray insertion method according to claim 1, wherein the step of determining whether the current frame displayed by the LCD is the dynamic frame or the static frame comprises:
retrieving a first frame previously display by the LCD;
retrieving a second frame currently display by the LCD;
determining that the LCD displays the dynamic frame when the second frame differs from the first frame; and
determining that the LCD displays is the static frame when the second frame is the same as the first frame.

3. The gray insertion method according to claim 1, wherein the step of determining whether the current frame displayed by the LCD is the dynamic frame or the static frame comprises:
retrieving a first frame previously display by the LCD;
retrieving a second frame currently display by the LCD;
generating a difference value according to the first frame and the second frame;
determining that the LCD displays the dynamic frame when the difference value is larger than a preset value; and
determining that the LCD displays is the static frame when the difference value is not larger than the preset value.

4. The gray insertion method according to claim 3, wherein the step of generating a difference value according to the first frame and the second frame comprises:
respectively determining whether a plurality of regions of the first frame is the same as a plurality of corresponding regions of the second frame; and
deciding the difference value according to a number of different corresponding regions between the first frame and the second frame.

5. The gray insertion method according to claim 1, wherein the step of determining whether the current frame displayed by the LCD is the dynamic frame or the static frame comprises:
retrieving a plurality of first frames previously display by the LCD;
retrieving a second frame currently display by the LCD;
calculating a number of continuous changes of the plurality of first frames and the second frame;
determining that the LCD displays the dynamic frame when the number of continuous changes is larger than a preset value; and
determining that the LCD displays is the static frame when the number of continuous changes is not larger than the preset value.

6. The gray insertion method according to claim 1, wherein the step of raising the gray insertion level of the LCD comprises:
increasing a display time of a gray insertion frame at a frame cycle.

7. The gray insertion method according to claim 1, wherein the step of lowering the gray insertion level of the LCD comprises:
reducing a display time of a gray insertion frame at a frame cycle.

8. The gray insertion method according to claim 1, wherein the step of raising the gray insertion level of the LCD comprises extending a charging time of a gray insertion frame.

9. The gray insertion method according to claim 1, wherein the step of raising the gray insertion level of the LCD comprises reducing a charging time of a gray insertion frame.

10. A driving circuit, applicable in a liquid crystal display (LCD), the driving circuit comprising:
a frame detector for determining whether a second frame is a dynamic frame or a static frame in accordance to a first frame previously display by the LCD and the second frame currently received by the LCD;
a gray insertion controller, coupling to the frame detector; and
a back light compensation unit, coupling to the frame detectors, wherein
when the second frame is the dynamic frame, the gray insertion controller raises the gray insertion level of the LCD and synchronously increases a duty cycle of a pulse width modulate (PWM) signal,
when the second frame is the static frame, the gray insertion controller lowers the gray insertion level of the LCD and synchronously reduces the duty cycle of the pulse width modulate (PWM) signal,
wherein the PWM signal is used to drive the back light module of the LCD.

11. The driving circuit of claim 10, wherein the frame detector comprises a storage unit for storing the first frame.

12. The driving circuit of claim 10, wherein when the first frame differs from the second frame, the frame detector determines the second frame is the dynamic frame, and when the first frame is the same as the second frame, the frame detectors determines the second frame is the static frame.

13. The driving circuit of claim 10, wherein the frame detector retrieves a difference value between the first frame and the second frame, and when the difference value is larger than a preset value, the frame detector determines the second frame is the dynamic frame, and when the difference value is not larger than the preset value, the frame detector determines the second frame is the static frame.

14. The driving circuit of claim 13, wherein the frame detector comprises a counter used in counting a number of different corresponding regions between the first frame and the second frame after the frame detector determines whether corresponding regions of the first frame and the second frame are the same or different, and the number is used as the difference value.

15. The driving circuit of claim 10, wherein the frame detector comprises:
a counter, accumulating a count value of the counter when two consecutive frames are different, and resetting the count value of the counter when the two consecutive frames are the same, wherein
when the count value is larger that a preset value, the frame detector determines the second frame as the dynamic frame, and
when count value is not larger than the preset value, the frame detector determines the second frame as the static frame.

16. The driving circuit of claim 10, wherein when the second frame is the dynamic frame, the gray insertion controller increases a display time of a gray insertion frame at a frame cycle, and when the second frame is the static frame, the gray insertion controller reduces the display time of the gray insertion frame at the frame cycle.

17. The driving circuit of claim 10, wherein when the second frame is the dynamic frame, the gray insertion controller extends a charging time of a gray insertion frame, and when the second frame is a static frame, the gray insertion controller reduces the charging time of the gray insertion frame.
